(19) United States
(12) Patent Application Publication
(10) Pub. No.: US 2016/0366564 A1
(43) Pub. Date: Dec. 15, 2016

(54) VERY HIGH FREQUENCY AIR/GROUND SIGNALS RECEIVER, VERY HIGH FREQUENCY SIGNALS TRANSMITTER AND CORRESPONDING TRANSMISSION METHOD

(71) Applicant: ALTYS TECHNOLOGIES, Toulouse (FR)

(72) Inventors: Alexandre Simonin, Toulouse (FR); Kanaan Abdo, Toulouse (FR); Fathia Ben Slama, Toulouse (FR)

(21) Appl. No.: 14/466,342

(22) Filed: Aug. 22, 2014

(30) Foreign Application Priority Data
Aug. 22, 2013 (FR) 1358112

(51) Int. Cl. H04W 4/04; H04W 24/02; H04L 12/26

(52) U.S. Cl. CPC H04W 4/046; H04L 43/028; H04W 24/02; H04W 28/0273

(57) ABSTRACT

The invention relates to a receiver of very high frequency band signals transmitted by a transmitter, comprising an antenna, a band-pass filter, a software-defined radio adapted to receive the signals filtered by said band-pass filter via a first input and to digitise said signals with a predetermined sampling rate in a predetermined sampling frequency band so as to obtain a digitised signal, characterised in that the receiver comprises at least two extraction modules each capable of receiving the digitised signal and of extracting part of the digitised signal, referred to as extracted signal, in a natural frequency channel, and at least two demodulators each capable of receiving an extracted signal and of demodulating said signal so as to retrieve data. The invention further relates to a very high frequency signals transmitter and to a corresponding transmission method.

### CROSS REFERENCE TO RELATED APPLICATIONS

This application claims priority under 35 U.S.C. §119(a) to French Patent Application Serial Number 1358112, filed Aug. 22, 2013, entitled “VERY HIGH FREQUENCY AIR/GROUND SIGNALS RECEIVER, VERY HIGH FREQUENCY SIGNALS TRANSMITTER AND CORRESPONDING TRANSMISSION METHOD”, the entire teachings of which are incorporated herein by reference.

### BACKGROUND OF THE INVENTION

Field of the Invention

The invention relates to a very high frequency air/ground signals receiver, to a very high frequency signals transmitter and to a corresponding transmission method.

Description of Related Art

Aircraft communicate with the ground by exchanging very high frequency signals, more commonly referred to as VHF signals. These signals allow data to be exchanged between the aircraft and the ground-based reception stations. These data are, for example, traffic data, data relating to the status of the aircraft systems or also communications between the pilots and the air-traffic controllers. Generally, the aircraft sends these data through signals on a plurality of frequency channels. On the ground, the simultaneous reception of transmissions generated on these frequency channels currently requires the use of an equivalent number of receivers and of a computing unit for controlling the receivers and for processing the data captured by these receivers.

This solution has several disadvantages, particularly the need for implementing N receivers for capturing N channels. This requirement generates problems in terms of costs and of the spatial requirement, as each receiver currently available on the market measures 1U in height, with the unit ‘U’ corresponding to the size of a location in a rack designed to store the electronic equipment.

Furthermore, as the radio interface of each receiver is closed, there is no feedback of detailed information relating to the physical signal.

Moreover, during a standard transmission procedure between a transmitter mounted on board an aircraft and a ground-based receiver, the receiver has to previously notify the transmitter which frequency channel it must use to transmit the signal to be transmitted in order to be able to be received and decoded by the receiver. This poses problems when the channel indicated by the receiver is saturated and therefore cannot be used by the transmitter. The transmitter does not have the possibility of adapting the transmission channel.

There is therefore a requirement for proposing a novel solution allowing the reception and the processing of VHF signals exchanged between an aircraft and the ground-based reception stations, whilst allowing adaptation of the frequency channel used as a function of the load of the available channels.

### BRIEF SUMMARY OF THE INVENTION

The object of the invention is to overcome at least some of the disadvantages of known devices and methods for transmitting air/ground VHF signals.

The object of the invention is to provide, in at least one embodiment of the invention, a receiver that dispenses with the need of having a plurality of receivers for receiving VHF signals on a plurality of channels.

A further object of the invention is to provide, in at least one embodiment of the invention, a receiver adapted to receive a large quantity of data to be processed in real-time.

A further object of the invention is to provide, in at least one embodiment of the invention, a receiver adapted to receive the signals transmitted by a transmitter of the aircraft in a frequency channel that is not determined in advance.

A further object of the invention, in at least one embodiment of the invention, is a transmitter adapted to select the frequency channel to be used to send signals based on criteria that are natural and not determined by the receiver.

A further object of the invention is to provide a transmission method adapted so that a transmitter can send signals on the frequency channels that it desires and so that the receiver receives these signals regardless of the selected frequency channels.

In order to achieve this, the invention relates to a receiver of very high frequency band signals transmitted by a transmitter, comprising:

an antenna configured to capture the very high frequency signals transmitted by the transmitter;

a band-pass filter adapted to filter the signals received by said antenna;

a software-defined radio adapted to receive the signals filtered by said band-pass filter via a first input and to digitise said signals with a predetermined sampling rate in a predetermined sampling frequency band in order to obtain a digitised signal,

characterised in that the receiver comprises:

at least two extraction modules each capable of receiving the digitised signal and of extracting part of the digitised signal, referred to as extracted signal, in a natural frequency channel; and

at least two demodulators each capable of receiving an extracted signal and of demodulating said signal so as to retrieve data.

Throughout the remainder of the document, the invention is described with reference to a transmission between a transmitter mounted on board an aircraft and a receiver located on the ground. Furthermore, the terms aircraft and transmitters are used to designate the transmitter located in an aircraft. Nevertheless, the invention is not limited to a single air/ground transmission between an aircraft and a ground-based station, but can also be used for transmissions coming from a plurality of aircraft or for transmissions from a ground-based station to an aircraft.

A receiver according to the invention therefore allows the reception, via a single receiver, of a plurality of different signals sent by the aircraft and captured by the antenna on the very high frequency band. The software-defined radio allows all of the signals sent in the VHF band and filtered by the band-pass filter to be combined into a single digital signal that will subsequently be processed in parallel by a plurality of extraction modules and demodulators. This parallel processing also allows the reduction of the throughput of the signal received by each extraction module and each demodulator. A receiver according to the invention is therefore able to fulfil the functions of a plurality of mono-channel receivers of the prior art. The spatial requirement of a receiver according to the invention is therefore reduced and the manufacturing cost is less than that of a plurality of mono-channel receivers. Furthermore, the parallel processing of the extracted signals allows real-time processing of a large quantity of data to be achieved. Moreover, within the context of a transmission between a transmitter and a receiver according to the invention, the reception of signals in a wide frequency band allows the signals sent by the transmitter to be received in a particular frequency channel, without having to previously determine the channel that will be used for the transmission. In other words, the transmitter sends a signal in the frequency channel that it desires, particularly as a function of the availability of the various channels for carrying out the transmission, and the receiver receives in a wide frequency band that contains this frequency channel and thus retrieves the information. This allows the transmitter to select the frequency channel that it desires so as to avoid, for example, the saturations of certain excessively used channels, whilst being assured that the receiver will capture the signals sent in this frequency as said receiver captures the signals on a wide frequency band. Furthermore, the receiver according to the invention no longer has to transmit a transmission frequency setpoint.

According to one variant, the receiver itself can determine the saturation of the various channels as it has access to the channel load information by capturing the entire frequency band. In this case, the receiver can send an instruction to the transmitter to use a seldom used transmission frequency. This also enables full compatibility with the existing transmitters, whilst improving the transmission.

Advantageously, and according to the invention, the number of extraction modules is equal to the number of demodulators.

A receiver according to this variant allows the provision of a plurality of parallel processing lines, with each line processing a predetermined frequency channel.

According to further variants, a demodulator can be associated with a plurality of extraction modules and a plurality of demodulators can be associated with an extraction module.

Advantageously, and according to the invention, the sampling rate is predetermined as a function of the demodulation speed of the demodulators and of the throughput reduction ratio of an extraction module, so as to optimise said sampling rates to allow real-time operation of the demodulators and to maintain the integrity of the data.

In order to retrieve all of the data coming from the aircraft and to efficiently and rapidly analyse the content of these data, the demodulators need to have real-time operation so that the data are processed in an allotted time and so that the demodulators do not delay in processing the signals. Therefore, the receiver as a whole is adapted to allow real-time processing by the demodulators. This adaptation of the receiver is even more significant as the digitisation of a frequency band by the software-defined radio results in the consolidation of all of the signals of the band into a single digitised signal with a significant throughput. This throughput is even more significant when a high sampling rate needs to be maintained during digitisation in order to preserve a maximum amount of information of the filtered signals during the digitisation, so as to maintain the integrity of the data retrieved at the output of the demodulators. The calculation of the sampling rate therefore responds to the following two constraints for optimising the sampling rate: being high enough to preserve the maximum amount of information during the digitisation of the filtered signals, and thus finally preserve the integrity of the data originating from these signals, and remaining weak enough for the demodulators to process the extracted signals in real-time.

According to this aspect of the invention, the maximisation of the sampling rate ensures that there will be little or no signal losses (and in the end, therefore, data losses) when digitising the signals received by the antenna. As the digitisation of a wide frequency band provides a significant amount of data, the sampling rate is determined as a function of the elements comprising the receiver so that the demodulators can work in real-time. This determination is undertaken, for example, according to this function: the maximum throughput at the output of the software-defined radio is equal to the product of the maximum throughput at the input of one demodulator among N for real-time operation and of the throughput reduction ratio of an extraction module. The throughput reduction ratio of an extraction module corresponds to the throughput reduction ratio on an incoming throughput of an extraction module. With the throughput expressed in bits per second, the division of this maximum throughput by the number of coding bits provides the sampling rate in numbers of samples per second. A sampling rate higher than the maximum sampling rate computed according to the function generates a digital signal with an excessively high throughput and the demodulators cannot process the extracted signals emitted from the extraction modules quickly enough to fulfil the real-time requirements of this type of equipment.

Advantageously, and according to the invention, each extraction module comprises a first sub-module capable of translating the central frequency of the digitised signal so that the central frequency of each extracted signal is equal to a frequency Fe that is identical for all of the modules at the output of the extraction modules, and of filtering the translated digitised signal.

5. According to this aspect of the invention, the extraction of the digitised signal into an extracted signal occurs by virtue of a translation and then by filtering. This extraction of the digitised signal in a natural frequency channel allows the receiver to retrieve a signal sent by the transmitter without previously knowing the frequency channel that the transmitter has selected for its transmission. In addition to the extraction of the digitised signal in a natural frequency channel, the filtering also allows the reduction of the data throughput at the output of the extraction module. The frequency translation and then the filtering of said digitised signal to a frequency Fe that is identical for all of the modules at the output of the extraction modules allows all of the demodulators to work on extracted signals with the same frequency Fe.

Advantageously, and according to the invention, at least one extraction module comprises a second sub-module capable of detecting the type of extracted signal and of reducing the output data throughput as a function of the type of signal detected.

According to this aspect of the invention, the detection of the type of signal allows the sub-module to carry out additional processing of the signal so as to reduce the output rate of the extraction module. In effect, knowledge of the type of extracted signal allows, for example, the sampling rate to be reduced if this does not affect the signal, so as to reduce the outgoing rate.

Advantageously, and according to the invention, the first sub-module and the second sub-module are configured to operate in parallel and to communicate with each other.

According to this aspect of the invention, the processing is quicker and there is no blockage if the two sub-modules do not process the signal at the same speed. Furthermore, each sub-module can adapt its processing as a function of the other sub-module.

Advantageously, and according to the invention, the receiver comprises a second antenna configured to capture the signals of a second frequency band, and the said software-defined radio comprises a second input adapted to receive these signals, with said software-defined radio being configured to digitise said signals of the second band in the signal digitised with the signals received via the first input.

According to this aspect of the invention, the receiver can retrieve signals present in a second band that is different to the very high frequency band. A different band is understood to be a frequency band that contains at least one frequency that is not included in the very high frequency band captured by the first antenna. The software-defined radio subsequently digitises the signals of this second band in the same digitised signal as the signals of the very high frequency band, so as to process all of the signals together.

Advantageously, and according to the invention, the receiver comprises a translation module adapted to translate the signals of the second frequency band to a frequency included in said sampling band of the software-defined radio and to transmit the translated signals to the second input of the software-defined radio.

According to this aspect of the invention, the signals captured by the second antenna are translated to a frequency included in the sampling band of the software-defined radio, so as to be able to sample the signals of the very high frequency band and the second band together. This translation allows a narrow sampling band to be preserved, which enhances the sampling quality particularly represented by the enhancement of the signal-to-noise ratio (SNR).

Advantageously, and according to the invention, the receiver comprises at least four extraction modules and at least four demodulators, so that said receiver can capture the frequencies on at least four channels.

According to this aspect of the invention, the receiver can capture the frequencies on at least four channels that correspond, for example, to at least four VDL2 channels, on which an aircraft generally transmits, and can process them in parallel.

Preferably, the receiver comprises six extraction modules and six demodulators so that said receiver can capture the frequencies on six channels.

Advantageously, and according to the invention, the software-defined radio, the extraction modules and the demodulators are adapted to communicate with each other via a transport protocol that is reliable in connected mode, i.e. by establishing a connection prior to the transporting of data, allowing an architecture to be supported that is distributed between a plurality of computing units.

Advantageously, and according to the invention, the software-defined radio, the extraction modules and the demodulators are adapted to communicate with each other via a transport protocol TCP.

According to this aspect of the invention, communications occur according to a transport protocol that allows the availability of the part that receives the information to be verified before the handshake transfer and allows a reliable exchange by virtue of the verification of errors. The reliability of the protocol allows processing that is distributed on a plurality of computers or backup processing in the event of a failure in one of the modules.

The invention further relates to a method for receiving very high frequency band signals transmitted by a receiver, comprising:
a step of receiving very high frequency signals transmitted by the transmitter;
a step of band-pass filtering of the signal received during the receiving step;
a step of high sampling rate digitisation of the signal filtered during the filtering step so as to obtain a digitised signal;

characterised in that it comprises:
at least two steps of extracting the digitised signal, said extraction steps being executed in parallel, with each of said extraction steps involving extracting part of the digitised signal, referred to as extracted signal, in a natural frequency channel; and
at least two demodulation steps executed in parallel, with each being executed following an extraction step and involving demodulating an extracted signal so as to retrieve the data.

A reception method according to the invention therefore allows the reception of a plurality of signals on a frequency band and can combine all of the sent and filtered signals of the VHF band into a single digital signal that will then be extracted and then demodulated for parallel processing.

A reception method according to the invention is advantageously implemented by a receiver according to the invention. A receiver according to the invention advantageously implements a reception method according to the invention.

The invention further relates to a very high frequency air/ground signals transmitter designed to implement a transmission method according to the invention, comprising:
a transmitter adapted to designate a transmission frequency;
a communication module adapted to receive a transmission request from said transmitter at said designated transmission frequency,
characterised in that said communication module comprises a sub-module for determining the availability of transmission frequencies and a sub-module for transmitting air/ground signals that is adapted to transmit said signals at a frequency that is:
equal to the designated transmission frequency if said frequency is valid;
equal to a frequency defined by said determination sub-module if the designated transmission frequency is not valid, with said selection being carried out as a function of the availability of the transmission frequencies.

The term “valid transmission frequency” is understood to be a frequency that is part of frequencies authorised by the standard for this type of communication. For example, within the context of a transmission according to standard ICAO 9776, the assigned frequencies in which the transmitter can transmit are: 136.975 MHz, 136.925 MHz, 136.875 MHz, 136.825 MHz, 136.775 MHz and 136.725 MHz.

A transmitter according to the invention therefore dispenses with any prior communication with the receiver for the selection of the transmission frequency. Therefore, the selection of the transmission frequency can be carried out according to criteria that are adapted to the current situation of the transmitter: for example, a frequency channel is often favoured by a plurality of transmitters, which causes the saturation of this frequency channel. Furthermore, certain valid transmission frequencies are seldom used in practice and therefore could be used instead of the saturated frequencies. The selection of the transmission frequency at the transmitter allows these saturations to be controlled by selecting a channel that is not saturated. Furthermore, the transmitter is the element that designates a transmission frequency for the transmission. If this designated frequency is valid, then the communication module will directly transmit the signals by using this frequency. If, on the contrary, this designated frequency is not valid, the communication module is responsible for selecting the transmission frequency, either randomly or by taking into account the saturation of the frequencies or as a function of the history of the use of the frequencies, etc. The prior verification of the validity of the frequency allows full compatibility with the existing ground-based receivers. The fact that this selection occurs only if the designated transmission frequency is not valid allows the system to be adapted to the ground-based receivers of the prior art: an existing transmitter will transmit a valid frequency, which frequency has been, according to the current standards, designated after a communication with a receiver. The communication module will then transmit using this valid frequency.

Advantageously, the transmitter according to the invention is used with a receiver according to the invention. The receiver according to the invention can monitor the availability of the usable transmission frequencies, the transmitter therefore transmits with the transmission frequency taking into account the availabilities of the transmission frequencies, and the opposite receiver captures the sent signals regardless of the frequency used by the transmitter. If the ground-based receiver is a receiver according to the invention, it may not impose the transmission frequency, leaving the selection of the frequency to the communication module: the transmitter can designate a non-valid transmission frequency, for example that is equal to 0, and the communication module will thereby deduce that it has to select the transmission frequency itself. This selection of the transmission frequency is advantageously carried out as a function of the availability of the transmission frequency so as to avoid the saturations of a transmission frequency, while a plurality of frequencies is authorised by the standard. According to one variant of the invention, the transmission frequency is selected as a function of the usage history of the authorised frequencies.

The invention further relates to a method for transmitting very high frequency signals, comprising:

a step of selecting a transmission frequency;

a step of transmitting signals at said selected transmission frequency;

a step of receiving signals;

characterised in that said step of receiving signals is carried out according to the reception method according to the invention.

A transmission method according to invention therefore allows a transmission of signals in which the transmission frequency is selected before the transmission, so that this selected transmission frequency is the most suitable in view of the constraints associated with this type of communication, such as, for example, interference from neighbouring transmitters, overloaded frequency channels, etc. The signal reception is carried out so as to be adapted to the selected transmission frequency, without prior knowledge of this transmission frequency.

Advantageously, the transmission method is implemented by the transmitter and the receiver according to the invention.

Advantageously, the transmitter and the receiver according to the invention implement the method according to the invention.

The invention further relates to a method, a transmitter and a receiver characterised in combination by all or part of the characteristics mentioned above or hereafter.

### BRIEF DESCRIPTION OF THE DRAWINGS

Further objects, features and advantages of the invention will become apparent upon reading the following description, which is provided solely by way of non-limiting example, and with reference to the accompanying drawings, wherein:

FIG. 1 is a schematic representation of an aircraft and of a receiver according to one embodiment of the invention;

FIG. 2 is a schematic representation of the operation of the transmitter and the modules and demodulators of the receiver according to one embodiment of the invention.

### DETAILED DESCRIPTION OF AN EMBODIMENT OF THE INVENTION

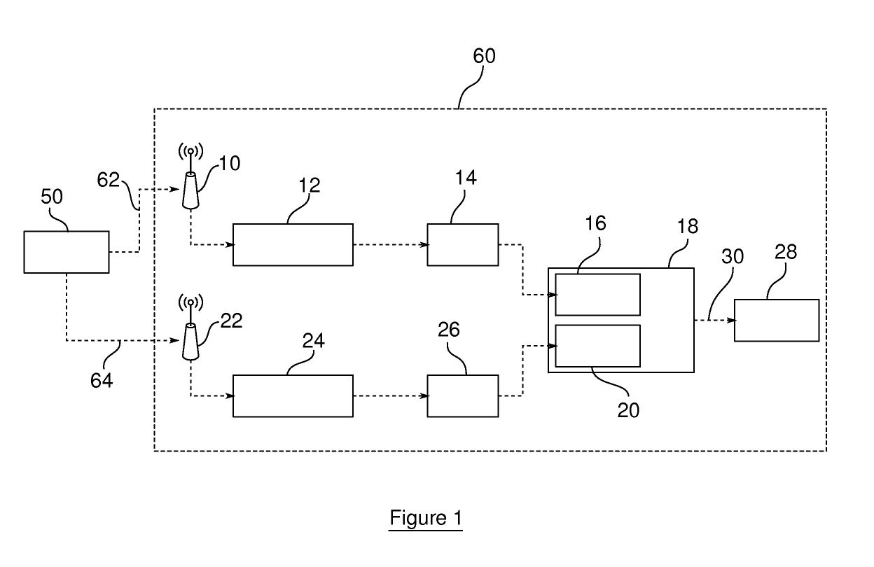

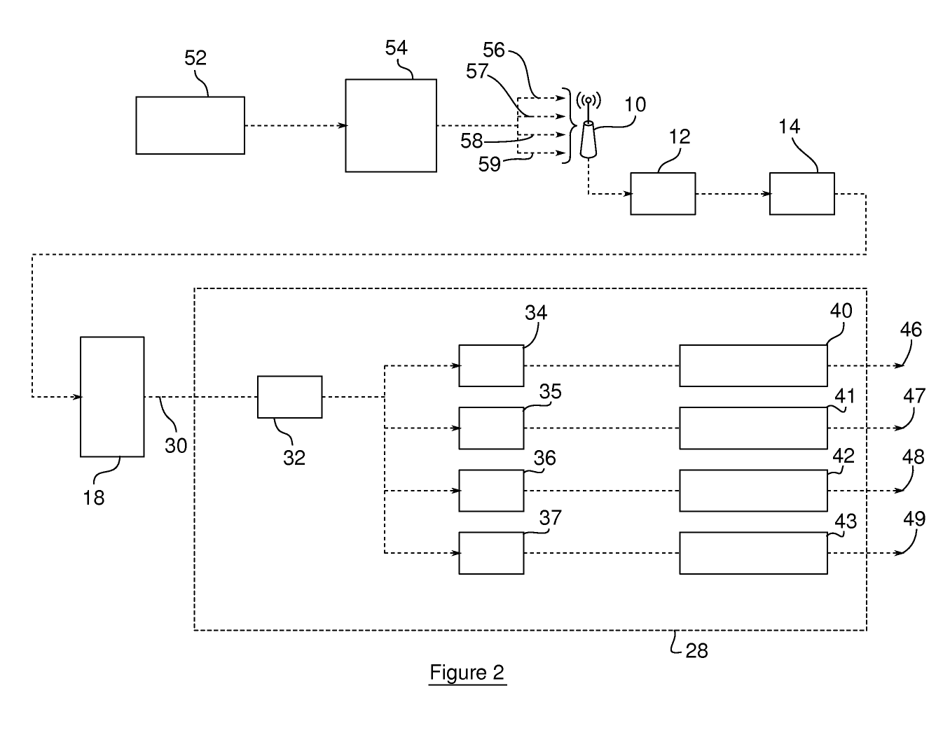

FIG. 1 shows an aircraft 50 and a receiver 60 according to one embodiment of the invention. The aircraft 50 transmits VHF signals 62 to the receiver 60 through a transmitter according to one embodiment of the invention, as shown in FIG. 2. At the same time, the aircraft can also transmit other signals 64 from a different frequency band through a transmitter, not shown.

The receiver 60 comprises a first antenna 10, which receives a signal 62, connected to a multi-channel band-pass filter 12 of the SAW (Surface Acoustic Wave) type and with a central frequency Fc. The signal at the output of the filter is amplified by a low noise amplifier LNA 14. The signal thus amplified is transmitted to a first input 16 of a software-defined radio card 18. The software-defined radio card 18 can be realised from a software-defined radio card SDR (Software-Defined Radio) such as the TVRX2 card marketed by Ettus Research. The software-defined radio card 18 digitises the signal with a sampling rate T and in a sampling band Be.

The software-defined radio card 18 is equipped with a second input 20 that can, in one embodiment of the invention, receive signals from a second frequency band designed to be digitised with the signals captured by the first antenna 10. These signals from a second frequency band are captured by a second antenna 22 and transmitted to a translation module 24 that will allow the translation of the main frequency of the signal, so that said signal is found in the sampling band Be of the software-defined radio card 18. Thus, all of the signals received by the software-defined radio card 18 are found in a predefined and narrow sampling band, which improves the signal-to-noise ratio of the digitised signal. The signal thus translated is transmitted to a low noise amplifier 26 and then to the second input 20 of the software-defined radio card 18.

In this embodiment, the first antenna 10 captures VHF signals 62 transmitted by an aircraft 50. These signals are, for example, VDL2 (VHF Data Link Mode 2) signals, which is a standard defined by the ICAO (International Civil Aviation Organization). The second antenna 22 captures, for example, a signal of the ADS-B (Automatic Dependent Surveillance-Broadcast) broadcast system. One of the signals available for this ADS-B system is the 1090 ES (Extended Squitter) signal, the transmission frequency of which is 1,090 MHz. The translation module 24 allows this frequency to be translated to an intermediate frequency of 465 MHz, which makes it possible to be in the sampling band of the selected software-defined radio card 18, which ranges from 50 MHz to 860 MHz.

Once the signal is digitised by the software-defined radio card 18, this signal is transmitted directly to a signal processing unit 28, for example a PC, more specifically described with reference to FIG. 2. This processing unit 28 also can be a DSP, for example. The connection between the software-defined radio card 18 and the processing unit 28 occurs via a Gigabit Ethernet connection 30 capable of transmitting the digitised signal with a significant throughput at this stage of the processing.

FIG. 2 schematically shows the operation of an embodiment of the VHF signals transmitter and of an embodiment of the receiver, with additional details on the processing unit 28.

According to one embodiment of the transmitter, said transmitter comprises a transmitter 52, as well as a communication module 54. In a system of the prior art, the transmitter forms the only intelligent part of the system, which is responsible for sending transmission requests to the communication module, which requests are then transmitted by said communication module. The transmitter also defines a transmission frequency for sending the signal, and the communication module uses this frequency to transmit the signal.

In this embodiment of the invention, the transmitter 52 defines a transmission frequency for sending the signal, and the communication module 54 then selects the transmission frequency on which it will transmit, without the transmitter 52 being notified of this selection. In this way, the communication module 54 verifies the validity of the transmission frequency defined by the transmitter 52, i.e. it verifies if this defined frequency belongs to the frequencies defined by the communication standard used for this type of signal. If the transmission frequency is valid, the communication module 54 transmits at this defined transmission frequency. In this case, a transmitter according to the invention performs identically to a transmitter of the prior art. If the transmission frequency is not valid, for example if the transmitter 52 defines a zero value, the communication module 54 selects the transmission frequency according to a method as described hereafter:

finding free frequencies, on which no transmission is ongoing;

selecting a transmission frequency by random selection;

verifying the transmission validity: if it is valid, the communication module 54 transmits with this transmission frequency, otherwise the communication module 54 carries out the selection again until a valid frequency is selected.

In an alternative embodiment, the frequency can be selected in a non-random manner from a list that is ordered according to the usage history of the transmission frequencies, in order to favour the least used channels. As a further alternative, the frequency can be selected in a non-random manner according to the saturation of the various transmission frequencies.

Once the transmission frequency is selected, the communication module sends the signal with this frequency. The selection of the transmission frequency before each transmission over time generates the transmission of a plurality of signals at different frequencies 56, 57, 58 and 59. The antenna 10 of the receiver captures a wide frequency band and therefore receives all of the signals 56, 57, 58 and 59, regardless of their transmission frequencies, provided that they are valid.

The function of the processing unit 28 of the receiver according to one embodiment of the invention is to retrieve the data contained in the digitised signal. As the signals originate from the aircraft, these data can be position data, avionics data, messages and other information related to the aircraft 50. The processing unit 28 comprises a controller 32, extraction modules 34, 35, 36, 37 and demodulators 40, 41, 42, 43. Throughout the remainder of the description, a single extraction module will be designated by reference numeral 34 and a single demodulator will be designated by reference numeral 40, without this limiting the characteristics of the other extraction modules or demodulators with similar characteristics. The software-defined radio card 18 is connected to the processing unit 28 via the Gigabit Ethernet connection 30 that is processed by the controller 32. The controller 32 is used to receive the received digitised signal and to carry out any transformations to allow the processing of this digitised signal by the software components of the processing unit 28. Thus, using the TCP protocol, the controller 32 transmits the digitised signal to the four extraction modules 34, 35, 36, 37, the function of which is to extract a signal extracted from a frequency channel of the digitised signal. In effect, the digitisation of the signals of the very high frequency band has created a single digitised signal comprising all of the received signals. The extraction module 34 then has the role of extracting each signal of the digitised signal.

An extraction module 34 is divided into two sub-modules: a first sub-module carries out a translation of the frequency of the channel of interest. Following this translation, the first sub-module carries out digital filtering configured to extract the signal. The purpose of the translation and the filtering is for all of the extracted signals to have the same central frequency so that the demodulators 40, 41, 42, 43 receive signals that all have the same central frequency. In practice, the central frequencies of the extracted signals are brought to the frequency Fe=Fc=0.

The second sub-module analyses the extracted signal so as to determine the type. This analysis can, for example, involve a detection of a signal identification sequence.

The two sub-modules execute their tasks in parallel: the first sub-module processes a signal and stores the result of the processing in a stack, from which the second sub-module retrieves these results in order to carry out its processing.

At the output, the extraction module 34 transmits an extracted signal to the demodulators 40, 41, 42, 43 using the TCP protocol. According to one embodiment of the invention, the extraction modules 34, 35, 36, 37 and the demodulators 40, 41, 42, 43 are concatenated, i.e. there is one demodulator associated with one extraction module that processes only the extracted signal originating from one extraction module.

Alternatively, an extraction module 34 can be connected to a plurality of demodulators adapted to process the extracted signal originating from the extraction module 34, and a demodulator 40 can be connected to a plurality of extraction modules. This allows better resource management as it is possible to distribute the extracted signals as a function of the availabilities of the demodulators 40, 41, 42, 43.

The demodulators 40, 41, 42, 43 process the extracted signals and retrieve data therefrom, which data can be, depending on the retrieved signal, aircraft related data of the avionics type, position data, voice data, etc. Each demodulator is adapted to process one or more types of signals so as to retrieve data therefrom. The modulations that are currently encountered in the signals sent by the aircraft are, for example, QPSK, D8PSK modulations, etc. The data are retrieved by processing devices, not shown, using the outputs 46, 47, 48, 49.

In an alternative embodiment, the receiver can obtain the information relating to the saturation of the frequency channels, for example at the extraction modules 34, 35, 36, 37, the demodulators 40, 41, 42, 43 or the outputs 46, 47, 48, 49, and can transmit an instruction for the use of the transmission frequency to a transmitter of the prior art. Thus, the receiver according to the invention is compatible with the transmitters of the prior art, which do not select the transmission frequency, which makes it possible to improve the transmission even if the transmitter is not a transmitter according to the invention.

Therefore, a plurality of elements of the receiver allows a reduction in the throughput to be achieved.

Firstly, the extraction modules 34, 35, 36, 37 generate the first drop in the throughput of the signal to be processed.

The reduction in the throughput comes from the first sub-module: the purpose of the filter of the first sub-module is to retain from the digitised signal only the frequency channel that relates to the signal to be extracted. This selection of the frequency channel allows a reduction in the throughput to be carried out at the output of the first sub-module, as only part of the digitised signal exits the sub-module.

The second sub-module in turn allows a reduction in the throughput by virtue of the detection of the signal type. If the second sub-module detects that the signal type allows a reduction in throughput, it can carry out this reduction. For example, the second sub-module can detect that the sampling rate can be reduced without losing data from the signal and can thus reduce it so as to reduce the throughput at the output of the extraction module 34.

All of these elements reduce the throughput of the signal received by the demodulators 40, 41, 42, 43. In order for the demodulators 40, 41, 42, 43 to be able to work in real-time, the sampling rate of the software-defined radio card 18 can be selected as a function of the various previously described reductions of the throughput. For example, the case can be studied of a receiver comprising four demodulators 40, 41, 42, 43 and where each demodulator is limited to 0.67 Mbits/s as a maximum input throughput for real-time operation. The calculation takes into account the reduced throughput ratio on throughput entering an extraction module. For a reduced throughput ratio on a throughput of 28 entering an extraction module, 0.67 Mbits/s*28=18.8 Mbits/s is obtained, that is a sampling rate of 294 KSamples/sec for coding on 64 bits.

According to one embodiment of the transmission method according to the invention, the determination sub-module selects a transmission frequency as a function of the transmission request of the transmitter, of the availability of the transmission frequencies, of the usage history of the transmission frequencies or randomly, then the transmission sub-module transmits at this selected frequency. The receiver 60 has no a priori knowledge of the transmission frequency of the transmitted signals, but receives the signals 56, 57, 58, 59 through its antenna 10, which captures the VHF signals. The receiver 60 digitises all of the signals and then extracts them in their frequency channel so as to demodulate them and retrieve the data sent by the transmitter of the aircraft 50.

The invention is not limited to only the embodiments described. In particular, the receiver can be located in a ground-based station or an aircraft, and can receive signals from one transmitter or from a plurality of transmitters, etc. The transmitter can be located in an aircraft or in a ground-based station, and can send its signals to one or more receivers, etc.

1. A very high frequency (VHF) receiver, comprising:
an antenna configured to capture VHF signals transmitted by a transmitter;
a band-pass filter filtering the VHF signals received by said antenna;
a software-defined radio receiving the signals filtered by said band-pass filter via a first input and digitizing said signals with a predetermined sampling rate in a predetermined sampling frequency band in order to obtain a digitized signal,
at least two extraction modules each receiving the digitized signal and extracting part of the digitized signal in a natural frequency channel; and,
at least two demodulators each receiving the extracted part of the digitized signal and demodulating said extracted part of the digitized signal so as to retrieve data therefrom.

2. The receiver according to claim 1, wherein said predetermined sampling rate is predetermined as a function of a demodulation speed of the demodulators and of a throughput reduction ratio of at least one of the extraction modules, so as to optimize said sampling rate to allow real-time operation of the demodulators and to maintain integrity of the data.

3. The receiver according to claim 1, wherein each extraction module comprises a first sub-module translating a central frequency of the digitized signal so that a central frequency of each extracted signal is equal to a frequency identical for all of the extraction modules at an output of said extraction modules, and filtering the translated digitized signal.

4. The receiver according to claim 3, wherein at least one extraction module comprises a second sub-module detecting a type of extracted signal and reducing output data throughput as a function of the detected type.

5. The receiver according to claim 4, wherein said first sub-module and said second sub-module operate in parallel and communicate with one another.

6. The receiver according to claim 1, further comprising a second antenna capturing signals of a second frequency band, said software-defined radio further comprising a second input receiving said signals of the second frequency band and digitizing said signals of said second frequency band with the signals received via the first input.

7. The receiver according to claim 6, further comprising a translation module translating the signals of the second frequency band to a frequency included in said sampling band of the software-defined radio and transmitting the translated signals to said second input of the software-defined radio.

8. The receiver according to claim 6, wherein the receive comprises at least four extraction modules and at least four demodulators enabling said receiver to capture signals on at least four channels.

9. The receiver according to claim 6, wherein the software-defined radio, the extraction modules and the demodulators are adapted to communicate with one other via a transport control protocol (TCP).

10. A method for receiving very high frequency (VHF) band signals transmitted by a transmitter, the method comprising:
receiving a VHF signal transmitted by the transmitter;
band-pass filtering the signal;
high sampling rate digitizing the filtered signal;
at least twice extracting in parallel the digitized signal, with each said extraction comprising extracting part of the digitized signal in a natural frequency channel; and
at least twice demodulating in parallel the extracted digitized signal so as to retrieve the data.

11. A very high frequency (VHF) signal transmitter, comprising:
a transmitter designating a transmission frequency;
a communication module receiving a transmission request from said transmitter at said designated transmission frequency, said communication module comprising a first sub-module determining an availability of transmission frequencies and a second sub-module transmitting air/ground signals at a frequency that is equal to the designated transmission frequency if said frequency is determined by said first sub-module to be available, or equal to a frequency selected by said first sub-module if the designated transmission frequency is not valid, with said selection being carried out as a function of the availability of the transmission frequencies.
